(19) United States
(12) Patent Application Publication
(10) Pub. No.: US 2008/0149481 A1
(43) Pub. Date: Jun. 26, 2008

(54) Portable test station

(76) Inventor: Terrance Davidson Hurt, Bakersfield, CA (US)

Correspondence Address: Terrance Davidson Hurt, 18133 Buckboard Avenue, Bakersfield, CA, 93314, US

(21) Appl. No.: 12/005,548

(22) Filed: Dec. 26, 2007

Related U.S. Application Data
(60) Provisional application No. 60/877,191, filed on Dec. 26, 2006.

(51) Int. Cl. G01N 27/26

(52) U.S. Cl. 204/404

(57) ABSTRACT

A portable test station is disclosed in a unitary package that integrates a typical Copper-copper sulfate reference electrode with test apparatus. The electrode is maintained in a state of equilibrium by way of immersion in a liquid environment which prevents the solution contained within the electrode from leaching out of the electrode's porous end. This feature enables extended periods of reliable service not otherwise possible. The liquid environment also serves as a conductive bridge between the electrode's porous end and the installation site's environment. Continuity is achieved by way of an adjustable porous ceramic plug located in the base of the apparatus, which may be manipulated by the user prior to installation, i.e. water is allowed to leech from the apparatus into the environment through the exposed surface area of the ceramic plug which may be increased or decreased to suit a particular installation's need.

### CROSS-REFERENCE TO RELATED APPLICATIONS

U.S. Pat. No. 4,692,231

U.S. Pat. No. 5,469,048

### STATEMENT REGARDING FEDERALLY SPONSORED RESEARCH OR DEVELOPMENT

None—Not Applicable

### REFERENCE TO LISTING, AT TABLE, OR A COMPUTER PROGRAM LISTING COMPACT DISC APPENDIX

Not Applicable

### BACKGROUND OF INVENTION

Many industries (such as oil and gas, public utilities, municipalities and others) make extensive use of buried and or immersed metallic structures to transport and store product. It is well known that such metallic structures will corrode and deteriorate over time. It is therefore extremely important that measures be taken to protect against such corrosion and deterioration. One such measure is to coat the buried or immersed metallic structures to prevent it from contacting a conductive environment (electrolyte). However, coatings alone have proven ineffective as a principle means of protecting against corrosion and deterioration principally due to incomplete seals and degradation of the coating over a period of time.

A more reliable means of preventing metallic corrosion is through the application of cathodic protection. This practice recognizes that corrosion comes about as a result of low-level electrical reactions taking place between metallic elements of different voltage potential when exposed to, or immersed in, a conductive electrolyte. In such environments, metal of a more negative voltage potential will emit low levels of electrical current which, by way of the electrochemical process, results in metal loss, otherwise stated as corrosion. The application of cathodic protection utilizes this same principle by introducing a sacrificial metal into the electrical circuit. In order to be affective, the sacrificial metal must have a more negative potential than the most negative element of the metal to which cathodic protection is being applied. Moreover, It has been observed that if the most negative voltage potential of the metallic structure to which cathodic protection is being applied can be increased (made more negative) by a value of 0.1 volt or more, this same naturally occurring corrosion process of the metallic structure surface may be avoided. This can be accomplished by various methods, one of which involves introducing certain other metals (such as magnesium, referred to as a “sacrificial” metal) into the electrical circuit of the desired metallic structure. This particular method involves attaching a wire between the sacrificial metal and the metallic structure. The natural conductivity of the electrolyte then causes the corrosion process to occur to the sacrificial metal's surface instead of the metallic structure's surface. Cathodic protection systems are most commonly used to protect metallic (steel) water/fuel structures and storage tanks; steel pier piles, ships, offshore oil platforms and onshore oil well casings. (U.S. Pat. No. 4,692,231.)

Government regulations require that certain metallic structures deemed as critical be tested periodically to assure that the level, or degree, of applied cathodic protection is effective in accordance with the intended application. The most common and accepted practice of performing such tests involves measuring the metallic structure's voltage potential with cathodic protection applied. An approved, calibrated, and well maintained reference electrode is required to conduct such tests. A commonly used reference electrode is the Copper-copper sulfate (CuSo4) half-cell. However, other types of reference electrodes can be used to conduct such tests provided they are also approved, calibrated and well maintained. One such other electrode is the Silver Chloride electrode (commonly used for testing the voltage potential of metallic structure buried or immersed in seawater applications.)

A commonly used CuSo4 reference electrode (shown in the attached drawings) is in the form of a non-conductive cylindrical chamber having a porous end. A copper rod is suspended from the chamber top into the center of the chamber, and Copper-copper sulfate crystals are added to the annular space surrounding the copper rod. Distilled water is introduced into the chamber such that the copper rod becomes immersed in a saturated Copper-copper sulfate solution (a bluish fluid containing visible [not dissolved] Copper-copper sulfate crystals). The bottom of the electrode (the ‘pointed end’ as illustrated in the attached drawings) is porous, and is designed to be placed into direct contact with the electrolyte. This provides fluid conductivity from the electrolyte, through the porous membrane, through the dissolved Copper-copper sulfate solution to the copper rod. The opposite/exposed end of the copper rod is connected through a wire back to a testing unit, and another wire is extended from the testing unit to the metallic structure, thus completing an electrical circuit. See U.S. Pat. No. 5,469,048 (col. 6, line 40) for an example of such a testing device.

It is well known that the Copper-copper sulfate solution in the above described cylindrical units tends to leach out of the porous end if not sealed when not in use. This same leaching effect occurs if such a unit is left in place at a given location, such that the unit cannot be used for more than a few continuous days before drying-out and being rendered inoperable. It is therefore desirable to provide methods and apparatus for prolonging the useful life of a Copper-copper sulfate reference electrode, such that it may be left in place at a given location for an extended period of time to provide periodic and/or continuous information regarding the level of applied cathodic protection to buried or immersed metallic structure.

### BRIEF SUMMARY OF THE INVENTION

The present invention provides methods and apparatus for integrating a common Copper-copper sulfate reference electrode with a portable test station which itself includes a water reservoir feature. The apparatus is design is such a way that the user may control the release of water into the surrounding environment while maintaining the Copper-copper sulfate reference electrode in a state of equilibrium within a reservoir of water.

Maintaining the reference electrode in a state of equilibrium prevents the Copper-copper sulfate solution from leaching out of the reference electrode's porous end. This negates the existing concern for a reference electrode being rendered inoperable (drying-out) once left in place at a given location for more than a few continuous days.

The object of the invention is to provide methods and apparatus for prolonging the useful life of a typical Copper-copper sulfate reference electrode such that it may be left in place at a given location for an extended period of time to provide periodic and/or continuous information regarding the level of applied cathodic protection to buried or immersed metallic structure.

### BRIEF DESCRIPTION OF THE SEVERAL VIEWS OF THE DRAWING

1/4 Perspective view of the Portable Test Station apparatus being used to monitor the level of applied cathodic protection over a residential natural gas service line.

2/4 Exploded view of a typical Copper-copper sulfate reference electrode.

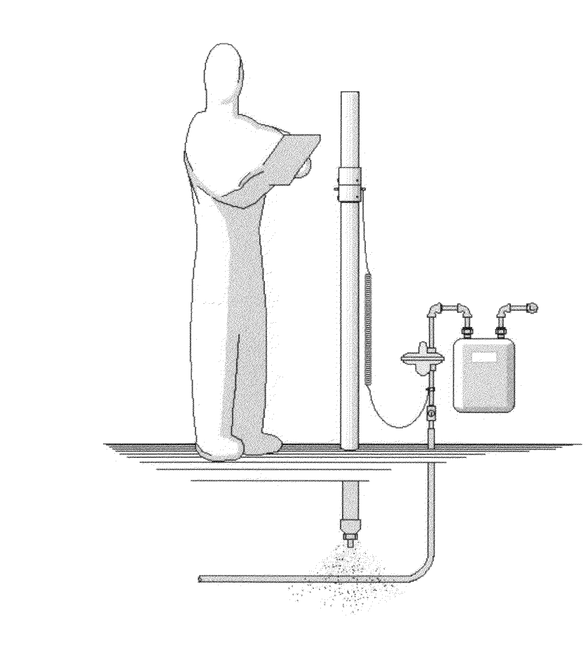

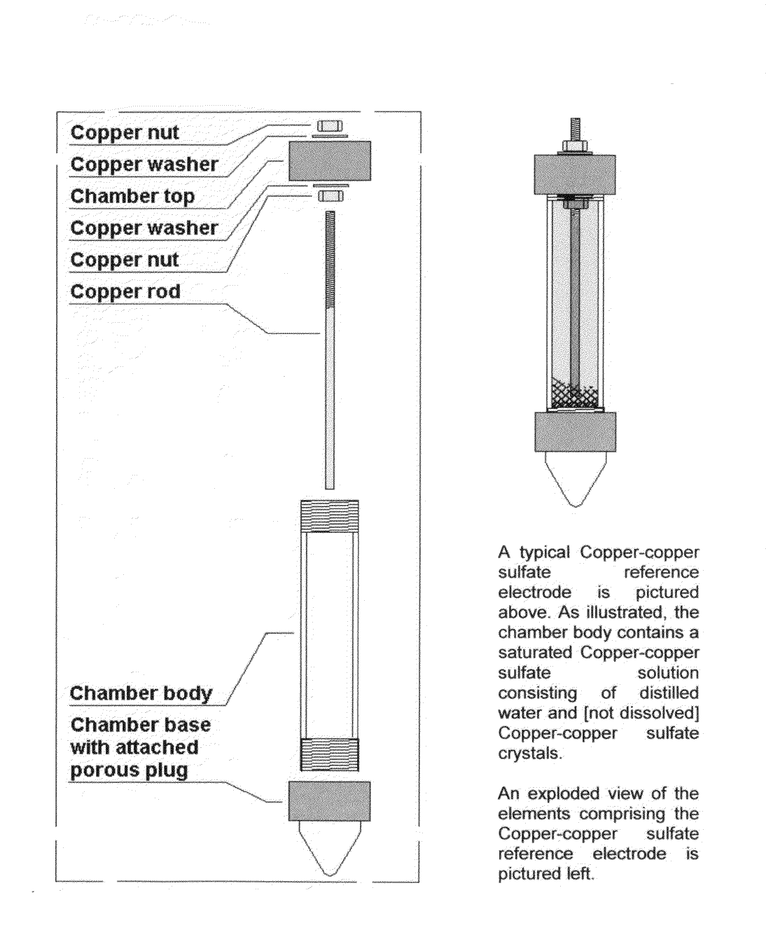

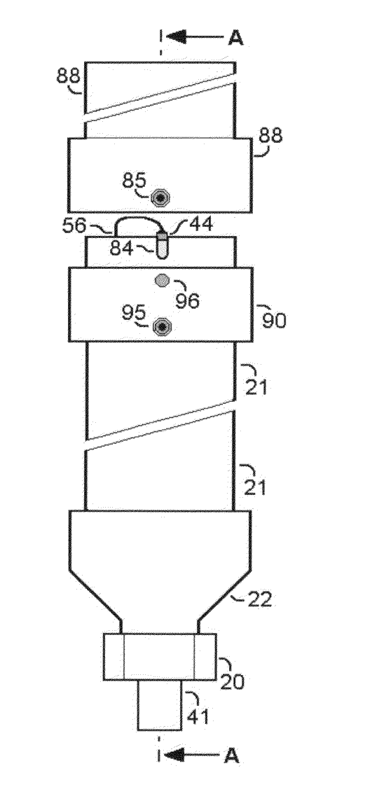

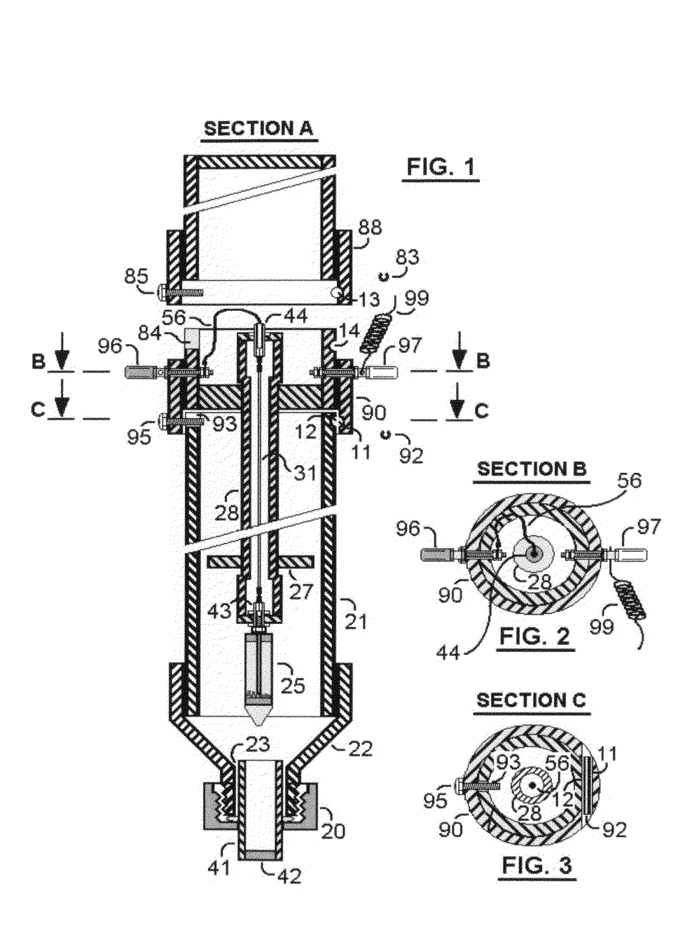

3/4 Fully assembled side view illustrating a forward looking sectional view (FIG. 1, SECTION A) of the Portable Test Station apparatus.

4/4 Internal forward-looking sectional view (FIG. 1, SECTION A) of the Portable Test Station apparatus, and two downward-looking sectional views (FIG. 2, SECTION B and FIG. 3, SECTION C) that, in total, display all elements of the apparatus.

### DETAILED DESCRIPTION OF THE INVENTION

The present invention provides portable testing apparatus and related methods that utilize a typical Copper-copper sulfate reference electrode to provide reliable and continuous measurement of a metallic structure's voltage potential for extended periods of time (several weeks or months) without the need for service.

In the preferred embodiment of the invention an elongated outer cylindrical tube 21 is provided having a large diameter. An example of such a tube 21 might be 6 feet long and 3 inches in diameter. The top of the outer tube is open, and is designed to receive a smaller internal tube 28 that is joined to a measurement apparatus 90 more particularly described below; the bottom is closed by way of an adjustable hollow cylindrical shaft 41, also described more fully below. An example of the smaller internal tube 28 might be 4½ feet long, and ½ inch in diameter. A cylindrical Copper-copper sulfate electrode 25 is electrically attached to the bottom end of the smaller internal tube 28, which is inserted into the larger outer tube 21 such that the electrode 25 is suspended above the bottom of the larger outer tube 21. A wire 31 is connected to the electrode 25 by way of a conductive fitting 43 that bridges the sealed lower end of the smaller internal tube 28, and extends up through the internal tube to a second conductive fitting 44 that bridges the sealed top end. A spacer (or bumper) 27 protrudes from the side of the smaller tube 28 to keep it roughly centered, and prevent the electrode 25 from contacting any internal surface within the larger outer tube 21. The larger outer tube 21 is filled with fluid (usually potable water), which surrounds the electrode and the internal smaller tube 28.

The bottom end of the larger tube may be tapered 22, and has a smaller opening 23 for receiving a hollow cylindrical porous material 41 which is sealed at the bottom most point with an internal plug of epoxy cement 42. The porous material 41 is preferably in the form of a ceramic material through which the fluid contained in the larger outer tube 21 can slowly pass or weep into the electrolyte, or environment, at the installation site. This ceramic material 41 is designed to come into direct contact with the electrolyte at the desired area over, or adjacent to, the metallic structure to be tested. Thus, the water in the larger outer tube 21 then slowly leaches or weeps through the ceramic material 41 into the electrolyte, maintaining conductivity between the Copper-copper sulfate reference electrode 25 and the surrounding electrolyte.

The porous material is provided in the form of a movable hollow porous ceramic shaft 41 that protrudes through the opening 23 in the bottom of the larger outer tube 21. The exposed surface area of the hollow porous ceramic shaft 41 can be manipulated prior to installation by sliding the shaft into, or away from, the opening 23 of the larger outer tube 21, prior to locking-in-place by way of a compression nut 20 or other appropriate compression device. The distance that the hollow porous ceramic shaft 41 extends out from the larger outer tube 21 may be varied according to the type and moisture content of the electrolyte where it is to be deployed. In dry electrolyte, it may be desirable for additional water to leach/weep through the ceramic to maintain good conductivity. In such a case, the hollow porous ceramic shaft 41 may be extended out several inches from the bottom of the larger outer tube 21. In moist electrolyte, less leaching/weeping of water may be required, such that the hollow porous ceramic shaft 41 may only need to be extended out an inch or less to maintain good conductivity with the electrolyte.

Because the Copper-copper sulfate reference electrode chamber cavity 25 is comprised of a liquid environment, the electrode achieves a state of equilibrium when suspended in the column of water within the larger outer tube 21. Thus, the Copper-copper sulfate solution inside the electrode chamber does not leach out of the porous plug. As such, as long as there is enough water in the larger outer tube 21 to cover the porous end of the reference electrode 25, and so long as the fluid conductivity to the electrolyte is maintained, the electrode will continue to provide accurate readings of the cathodic protection (voltage) of the metallic structure. Depending on the size of the larger outer tube 21, the amount of water used, and the rate of leaching/weeping into the electrolyte allowed by the extension of the hollow porous ceramic shaft 41, the Portable Test Station apparatus may provide accurate readings for several weeks or months.

The top of the smaller internal tube 28 bridges the base of the measuring apparatus 90 which is provided for mounting atop of the larger outer cylinder 21. The measuring apparatus 90 may be fixed in place or temporarily removed from the larger outer cylinder 21 by way of a press-pin 92. When fixed in place, the press-pin 92 may be inserted through an orifice that is common to both the measuring apparatus 90 and the larger outer cylinder 21 by way of a hole 11 drilled through the longitudinal axis of the measuring device 90 and a like hole 12 drilled through the longitudinal axis of the larger outer cylinder 21, provided the two are aligned and slipped together. Alignment is achieved by positioning the security nut 95 (installed through the measuring apparatus 90) directly above the notch 93 located in the top of the larger outer tube 21 and slipping the two together.

The wire 31 extending from the electrode 25 up the small internal tube 28 by way of the conductive fittings (43 and 44) is connected by a wire 56 to an insulated conductive fitting 96 that bridges the wall of the measuring apparatus 90. A second (usually exterior) wire 99 connects from the measuring apparatus 90 by way of a second insulated conductive fitting 97 to the metallic structure. The two exposed/insulated conductive fittings (96 and 97) that bridge the wall of the measuring apparatus 90 allow the operator to connect a testing device to the electrical circuit without having to remove the electronics cover 88 from the measuring apparatus 90, and also allow the operator to obtain test data without coming in direct contact with the electrical circuit. Internally (within the measuring apparatus 90) these same insulated conducive fittings (96 and 97) provide a means of connecting a wired data recording device, or a wireless data transmission device, to the Portable Test Station apparatus. This feature is significant in that it allows for data acquisition without the need for an operator to physically visit the site.

The electronics cover 88 that may be 16″ long and 3″ in diameter is provided to house such equipment, and may be fixed in place or temporarily removed from atop of the measuring apparatus 90 in the same manner as previously described to fix in place or temporarily remove the measuring apparatus 90 from the larger outer cylinder 21. Specifically, the electronics cover 88 may be fixed in place or temporarily removed from the measuring apparatus 90 by way of a press pin 83. When fixed in place, the press pin may be inserted through an orifice that is common to both the electronics cover 88 and the measuring apparatus 90 by way of a hole 14 drilled through the longitudinal axis of the measuring apparatus 90 and a like hole 13 drilled through the longitudinal axis of the electronics cover 88, provided the two are aligned and slipped together. Alignment is achieved by positioning the security nut 85 (installed through the electronics cover 88) directly above the notch 84 located in the top of the measuring apparatus 90 and slipping the two together.

1. In combination, a portable apparatus for testing the level of applied cathodic protection to metallic structure buried or immersed in electrolyte, said apparatus providing unencumbered access to a common reference electrode that is maintained in a state of equilibrium by way of suspension in a liquid environment that in turn provides moisture and electrical continuity to the surrounding environment by way of a hollow porous ceramic plug which may be adjusted to either increase or decrease the exposed ceramic surface area, thereby providing a conductive interface between the electrode; the water reservoir; and the surrounding electrolyte.

2. The combination set forth in claim 1 wherein the water reservoir consists of an external elongated cylindrical tube made up of dielectric material having a removable top at one end expressly intended for the introduction of water into the apparatus, and an adjustable cylindrical porous plug at the bottom end expressly intended to provide a means whereby the rate of water allowed to discharge from the apparatus into the environment may be controlled.

3. The combination set forth in claim 2 wherein the exposed surface area of the cylindrical porous plug may be manipulated prior to installation by sliding the plug into, or away from, the opening through which it is inserted prior to locking-in-place by way of a compression nut or other appropriate compression device.

4. The combination set forth in claim 2 together with an internal cylindrical tube made up of dielectric material which is an appendage of, and joined to, said removable top.

5. The combination set forth in claim 4 wherein said internal tube contains a wire that runs the length of the longitudinal axes thereby providing electrical continuity between conductive fittings located top and bottom of said internal tube ends.

6. The combination set forth in claim 4 wherein said internal tube is sufficient in length such that when a typical Copper-copper sulfate reference electrode is attached by screw method to the bottom conductive fitting, the electrode is suspended no more than eight inches distant the hollow porous ceramic shaft's terminus.

7. The combination set forth in claim 4 wherein a spacer is installed at the lower end of said smaller internal tube to keep it roughly centered, thus preventing the reference electrode from contacting the larger external tube's internal surface.

8. The combination set forth in claim 2 wherein the removable top (measuring apparatus) is joined to the larger external tube by ‘slip’ method after aligning a security bolt installed through the removable top's cylindrical wall with a slot provided in the larger external tube's cylindrical wall.

9. The combination set forth in claim 8 wherein the removable top is secured to the larger external tube, following alignment and slip connection, by inserting a press pin through a drilled orifice that traverses the horizontal axes of the common and aligned slip joint's cylindrical wall, located opposite the aligning security bolt.

10. The combination set forth in claim 2 wherein an electronics cover may be joined to the removable top (measuring apparatus) by ‘slip’ method after aligning a security bolt installed through the electronics cover with a slot provided in the removable top's cylindrical wall.

11. The combination set forth in claim 10 wherein the electronics cover is secured to the removable top, following alignment and slip connection, by inserting a press pin through a drilled orifice that traverses the horizontal axes of the common and aligned slip joint's cylindrical wall, located opposite the aligning security bolt.
